(19) United States
(12) Patent Application Publication
(10) Pub. No.: US 2026/0019150 A1
(43) Pub. Date: Jan. 15, 2026

(54) DEVICE AND METHOD FOR DISPERSION MEASUREMENT FROM RECEIVED SIGNAL

(71) Applicant: Point2 Technology, Inc., Gangnam-gu Seoul (KR)

(72) Inventors: Taeho KIM, Gangnam-gu Seoul (KR); Jinho PARK, Yongsan-gu Seoul (KR); Jake EU, Gangnam-gu, Seoul (KR); Hyosup WON, Gwanak-gu, Seoul (KR); Jungi JO, Yeonsu-gu, Incheon (KR)

(21) Appl. No.: 18/574,438

(22) PCT Filed: Dec. 28, 2022
(86) PCT No.: PCT/KR2022/021522

§ 371 Date: Sep. 2, 2025

(51) Int. Cl. H04B 10/079; H04B 10/2513

(52) U.S. Cl. CPC H04B 10/079; H04B 10/2513

(57) ABSTRACT

The present disclosure may provide a device and method for dispersion measurement from a received signal. The device may include a boundary checker configured to measure a shape of eye diagram of a sampled received signal; and a dispersion quantity estimator configured to estimate the dispersion quantity based on the shape of eye diagram. According to the present disclosure, it is possible to provide a technical method capable of quantitatively measuring and using the dispersion quantity from the shape of eye diagram distorted by the dispersion due to an optical path in a receiver.

### BACKGROUND

### 1. Field

The present disclosure relates to dispersion measurement of a signal, and more particularly, to a device and method for dispersion measurement from a received signal.

### 2. Description of Related Art

With the development of information and communication technology, there is a need to transmit a large amount of data at high speed. As one of the methods for implementing this, a transmission system based on an optical interface may be applied.

To transmit the large amount of data at high speed, multilevel signaling methods such as non-return to zero (NRZ) and pulse amplitude modulation (PAM) may be applied. Characteristics of signals received after passing through an optical fiber may be evaluated through eye diagram measurement. It may be determined that the larger and clearer the eye opening, the better the bit error rate (BER) of the received signal.

Meanwhile, when transmitting high-speed data using an optical path, dispersion may occur due to a transmission distance. This dispersion is a pulse spreading phenomenon that occurs since various components in an input pulse have different speeds, and may distort the eye shape of the received signal, and the distorted signal may lower the BER in a receiver. In addition, when transmitting the high-speed data using the optical fiber, the transmission distance may be limited by the dispersion depending on the transmission speed and optical fiber length.

Accordingly, there is a need to develop new technical methods capable of improving system performance by quantitatively measuring a dispersion quantity due to optical paths in a high-speed optical transmission and reception system.

### SUMMARY

The present disclosure provides a device and method for dispersion measurement from a received signal.

According to an embodiment of the present disclosure, there is provided a device for dispersion measurement from a received signal. The device may include a boundary checker configured to measure a shape of eye diagram of a sampled received signal; and a dispersion quantity estimator configured to estimate the dispersion quantity based on the shape of eye diagram.

In addition, the boundary checker may be configured to determine a phase difference between an eye upper boundary peak and an eye lower boundary peak in the shape of eye diagram. The dispersion quantity estimator may be configured to estimate the dispersion quantity based on the phase difference.

In addition, the dispersion quantity estimator may be configured to estimate a transmission distance proportional to the dispersion quantity based on the phase difference.

In addition, the dispersion quantity estimator may be configured to determine a first-order linear model between the phase difference and the transmission distance and estimate the transmission distance based on the first-order linear model.

In addition, the dispersion quantity estimator may be configured to estimate a positive dispersion quantity or a negative dispersion quantity based on a sign of a value of the phase difference.

In addition, the device may further include a dispersion compensation filter configured to filter the received signal to reduce the phase difference based on the positive dispersion quantity or the negative dispersion quantity.

According to an embodiment of the present disclosure, there is provided a method of dispersion measurement from a received signal. The method may include: measuring a shape of eye diagram of a sampled received signal; determining a phase difference between an eye upper boundary peak and an eye lower boundary peak of the shape of eye diagram; and estimating a dispersion quantity based on the phase difference.

### BRIEF DESCRIPTION OF DRAWINGS

FIG. 1 is an exemplary graph illustrating a dispersion quantity according to an optical fiber type.

FIG. 2 is an exemplary graph illustrating the dispersion quantity according to a light wavelength of an optical fiber.

FIG. 3A is an exemplary eye diagram of an optical signal received when a transmission distance is 0 km.

FIG. 3B is an exemplary eye diagram of the optical signal received when the transmission distance is 15 km.

FIG. 3C is an exemplary eye diagram of the optical signal received when the transmission distance is-15 km.

FIG. 4A is a schematic diagram illustrating modeling of the eye diagram of the optical signal received when the transmission distance is 0 km.

FIG. 4B is a schematic diagram illustrating modeling of the eye diagram of the optical signal received when the transmission distance is 15 km.

FIG. 4C is a schematic diagram illustrating modeling of the eye diagram of the optical signal received when the transmission distance is-15 km.

FIG. 5 is a schematic diagram illustrating a device for dispersion measurement from a received signal according to an embodiment of the present disclosure.

FIG. 6 is a schematic flowchart illustrating a method of dispersion measurement from a received signal according to an embodiment of the present disclosure.

### DETAILED DESCRIPTION

Hereinafter, exemplary embodiments of the present invention will be described in detail with reference to the accompanying drawings. First, it is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Various aspects of the invention are described below. It is to be understood that the inventions presented herein may be implemented in a wide variety of forms and that any particular structure, function, or both, presented herein is illustrative only. A person skilled in the art to which the present invention pertains will understand that one aspect presented herein can be implemented independently of any other aspects based on the inventions presented herein and that two or more of these aspects may be combined in a variety of ways. For example, a device may be implemented or a method may be practiced using any number of the aspects set forth herein. In addition, such a device may be implemented or such a method may be practiced using other structure, functionality, or structure and functionality in addition to or other than one or more aspects described herein.

The present disclosure may be applied to a receiver of optical communication, but is not limited thereto, and may be applied to various communication devices.

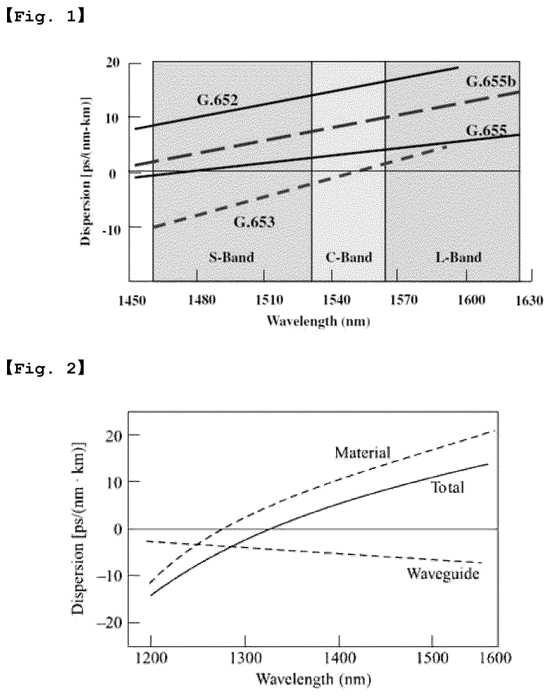

FIG. 1 is an exemplary graph illustrating a dispersion quantity according to an optical fiber type.

The International Telecommunication Union Telecommunication Standardization Sector (ITU-T) regulates types of optical fibers according to characteristics of the optical fibers, and ITU-T G. 652 specifies a standard single mode fiber (SMF) that is widely used in optical communications. As illustrated in FIG. 1, the G.652 optical fiber has low loss characteristics at 1550 nm, which belongs to a C-band, but causes optical dispersion, so it is necessary to compensate for this optical dispersion for long-distance, high-speed transmission. In general, as a length of a wavelength becomes longer and a transmission distance increases, the dispersion of the optical fiber may increase.

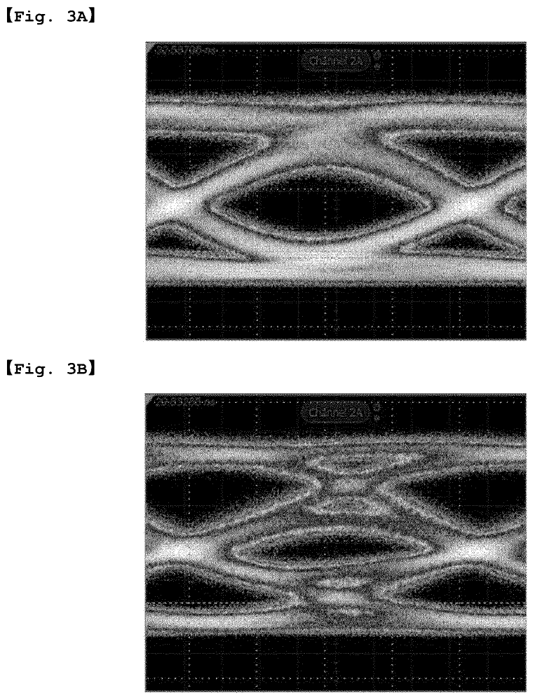

FIG. 2 is an exemplary graph illustrating the dispersion quantity according to a light wavelength of the optical fiber.

Chromatic dispersion (CD) is a major performance limiting factor for the single mode fiber (SMF), and may be composed of dispersion due to a material and dispersion due to a structure (waveguide). The material dispersion may occur due to wavelength dependence of a refractive index of a medium, and the structural dispersion may occur due to wavelength dependence of phases and group velocities, which are different for each propagation mode. As illustrated in FIG. 2, the chromatic dispersion approaches 0 at a wavelength of 1310 nm and increases as the wavelength becomes longer, resulting in a dispersion of about 17 ps/nm/km at 1550 nm, which is suitable for long-distance transmission.

For example, a transmittable distance based on the dispersion and transmission speed may be modeled as follows.

$$L = \frac{104 , 000}{CD * {B}^{2}} \qquad [ Equation 1 ]$$

Here, L denotes the transmission distance (km), CD denotes the chromatic dispersion (ps/nm/km), and B denotes a bit rate (Gbps).

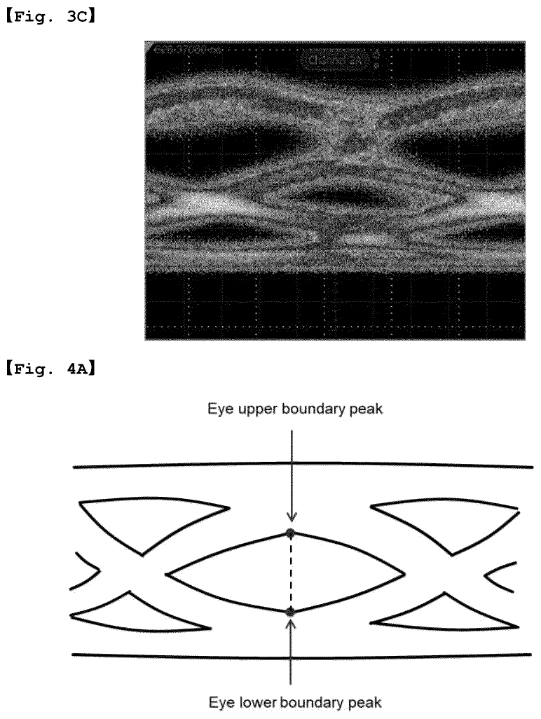

FIG. 3A is an exemplary eye diagram of an optical signal received when a transmission distance is 0 km, FIG. 3B is an exemplary eye diagram of the optical signal received when the transmission distance is 15 km, and FIG. 3C is an exemplary eye diagram of the optical signal received when the transmission distance is-15 km.

FIG. 3A is an eye diagram when the transmission distance is 0 km at a wavelength of 1550 nm, and thus, there is no chromatic dispersion (CD). As illustrated, it can be seen that there is no distortion in the eye diagram and the eye opening appears large and clear. FIG. 3B is an eye diagram when the transmission distance is 15 km and the chromatic dispersion (CD) is 240 ps/nm/km at a wavelength of 1550 nm. As illustrated, it can be seen that an eye opening of the eye diagram is distorted and narrowed, and the distorted signal may lower a bit error rate (BER) at a receiver. In addition, FIG. 3C is an eye diagram when the transmission distance is-15 km and the chromatic dispersion (CD) is −240 ps/nm/km at a wavelength of 1550 nm using a dispersion compensation filter device. As illustrated, it can be seen that the eye opening of the eye diagram is distorted and narrowed, and the distorted signal may lower the BER at the receiver.

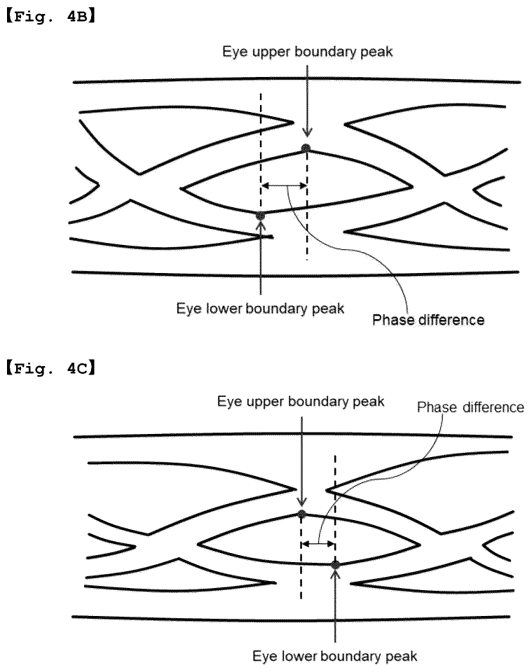

FIG. 4A is a schematic diagram illustrating modeling of the eye diagram of the optical signal received when the transmission distance is 0 km, FIG. 4B is a schematic diagram illustrating modeling of the eye diagram of the optical signal received when the transmission distance is 15 km, and FIG. 4C is a schematic diagram illustrating modeling of the eye diagram of the optical signal received when the transmission distance is −15 km.

As illustrated in FIG. 4A, when the transmission distance is 0 km or a short distance, there is substantially no dispersion due to an optical path. In this case, there is no phase difference between the eye upper boundary peak and the eye lower boundary peak on the eye opening.

Meanwhile, as illustrated in FIG. 4B, when the transmission distance is applied as 15 km, the eye opening may be distorted clockwise due to positive dispersion due to the optical path, and depending on the dispersion quantity, a positive phase difference determined by (phase value of eye upper boundary peak)-(phase value of eye lower boundary peak) may occur. In addition, as illustrated in FIG. 4C, when the transmission distance is applied as −15 km, the eye opening may be distorted counterclockwise due to negative dispersion due to the optical path, and depending on the dispersion quantity, a negative phase difference determined by (phase value of eye upper boundary peak)-(phase value of eye lower boundary peak) may occur.

As will be described later, the present disclosure may quantitatively estimate the dispersion quantity due to the optical path based on the (distorted) shape of the eye diagram.

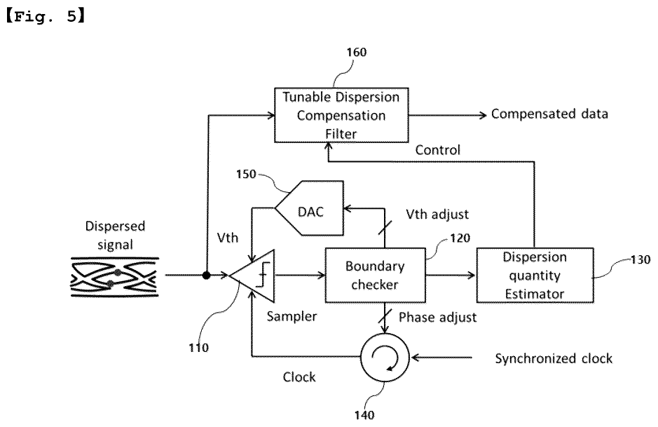

FIG. 5 is a schematic diagram illustrating a device for dispersion measurement from a received signal according to an embodiment of the present disclosure.

As illustrated in FIG. 5, the device may include a sampler 110, a boundary checker 120, a dispersion quantity estimator 130, a phase adjuster 140, a digital-to-analog converter (DAC) 150, and a dispersion compensation filter 160.

The sampler 110 may perform sampling on input data of the received signal based on a sampling clock Clock and a voltage threshold Vth. As described above, the received signal may be a dispersed signal in which the dispersion occurs due to the optical path. The boundary checker 120 may be configured to measure the shape of eye diagram of the sampled received signal, and the dispersion quantity estimator 130 may be configured to estimate the dispersion quantity based on the measured shape of eye diagram.

Specifically, the boundary checker 120 may determine the phase difference between the eye upper boundary peak and the eye lower boundary peak of the measured shape of eye diagram, and the dispersion quantity estimator 130 may estimate the dispersion quantity in the received signal based on the determined phase difference. In addition, since the dispersion quantity appears in proportion to the transmission distance, the dispersion quantity estimator 130 may estimate the transmission distance based on the determined phase difference.

In one implementation, the estimation of the dispersion quantity (or transmission distance) based on the phase difference may be performed by using a comparison table acquired through experimental data obtained by measuring the phase difference according to the dispersion quantity (or transmission distance), or performed by determining a first-order linear model between the phase difference and the dispersion quantity (or transmission distance) based on the experimental data.

For example, when the phase difference between the eye upper boundary peak and the eye lower boundary peak is 0.2 unit interval (UI) under the condition of the transmission distance of 15 km, the transmission distance may be estimated using the first-order linear model as shown in the following Equation.

$$\begin{matrix}0.2 : 15 Km = Δ P h : L \\ L \approx 5 \times Δ Ph \times 15 Km\end{matrix} \qquad [ Equation 2 ]$$

Here, L denotes the transmission distance, and ΔPh denotes the phase difference (interval) measured at 1550 nm (i.e., (phase value of eye upper boundary peak)-(phase value of eye lower boundary peak)).

In addition, as described above with reference to FIG. 4B, when the positive dispersion is present, the eye opening may be distorted clockwise and ΔPh may have a positive value. In addition, as described above with reference to FIG. 4C, when the negative dispersion is present, the eye opening may be distorted counterclockwise and ΔPh may have a negative value. Accordingly, the dispersion quantity estimator 130 may be configured to estimate the positive dispersion quantity or the negative dispersion quantity based on the sign of the value of the phase difference measured.

The dispersion compensation filter 160 may be configured to be tunable to compensate for the dispersion of the received signal based on the dispersion quantity estimated by the dispersion quantity estimator 130. The dispersion compensation filter 160 may filter the received signal to reduce the phase difference of the eye diagram based on the estimated positive dispersion quantity or negative dispersion quantity. For example, the dispersion compensation filter 160 may compensate for the received signal so that the eye opening is rotated counterclockwise to reduce the phase difference when the positive dispersion is present, and compensate for the received signal so that the eye opening is rotated clockwise to reduce the phase difference when the negative dispersion is present. To this end, the dispersion compensation filter 160 may apply an optical compensation method or an electronic compensation method to remove or alleviate the interference phenomenon due to the chromatic dispersion, depending on the implementation.

The boundary checker 120 may be additionally configured to determine a phase adjustment value and a voltage threshold adjustment value for selecting a sampling point with best BER performance from the shape of eye diagram of the measured received signal (where the dispersion is present). The phase adjuster 140 may adjust the phase of the sampling clock based on the phase adjustment value received from the boundary checker 120 and provide the adjusted phase to the sampler 110. In addition, the DAC 150 may provide the adjusted voltage threshold Vth to the sampler 110 based on the voltage threshold adjustment value received from the boundary checker 120.

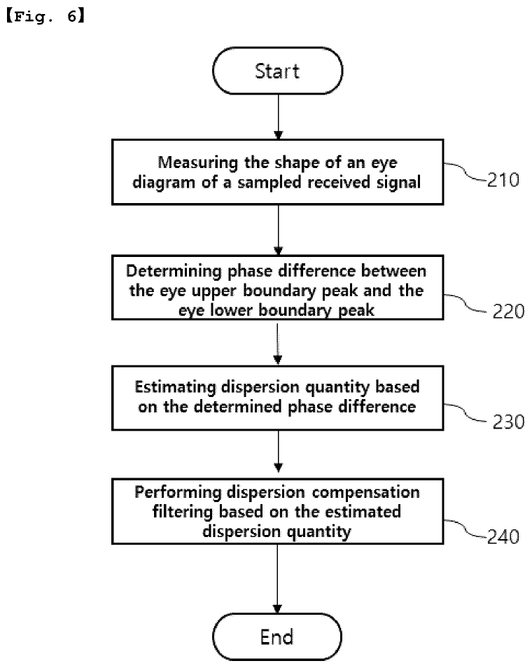

FIG. 6 is a schematic flowchart illustrating a method of dispersion measurement from a received signal according to an embodiment of the present disclosure.

As illustrated in FIG. 6, in the method of dispersion measurement from a received signal performed by the device of FIG. 5, the boundary checker 120 may measure the shape of eye diagram of the sampled received signal (210), and determine the phase difference between the eye upper boundary peak and the eye lower boundary peak in the measured eye diagram (220). The dispersion quantity estimator 130 may estimate the dispersion quantity (or transmission distance) based on the phase difference (230). The dispersion compensation filter 160 may perform the dispersion compensation filtering on the received signal based on the estimated dispersion quantity (240).

As described above, the present disclosure presents an advanced technical method that can quantitatively measure the dispersion quantity (or transmission distance) through the eye diagram analysis of the received signal and use the measured dispersion information to improve the BER of the receiver.

It is to be understood that any particular order or hierarchy of steps in any presented process is an example of exemplary approaches. It is to be understood that the specific order or hierarchy of steps in processes may be rearranged within the scope of the present invention, based on design priorities. The appended method claims provide elements of various steps in an exemplary order but are not meant to be limited to the particular order or hierarchy presented.

The terms used herein “component”, “unit (or part)”, “module”, “system”, etc., refer to a computer-related entity, hardware, firmware, software, a combination of software and hardware, or an implementation of software. For example, the devices and components described herein may be implemented using one or more general-purpose or a special-purpose computing device such as a processor, a controller, a digital signal processor (DSP), a field programmable gate array (FPGA), a programmable logic unit (PLU), and a microprocessor. For example, the component may be, but is not limited to, a process running on a processor, a processor, an object, an execution thread, a program, and/or a computer. For example, both an application running on a computing device and the computing device may be a component. One or more components may reside within a processor and/or an execution thread, and one component may be localized within one computer, or distributed between two or more computers. In addition, these components may be executed from various computer-readable media having various data structures stored therein.

According to the present disclosure, it is possible to provide the technical method capable of quantitatively measuring the dispersion quantity from the shape of eye diagram distorted by the dispersion due to the optical path in the receiver.

In addition, according to the present disclosure, it is possible to provide the technical method capable of determining the transmission distance through the information on the measured dispersion quantity.

In addition, according to the present disclosure, it is possible to use the measured dispersion information as the control value to improve the BER of the receiver.

The description of the presented embodiments is provided to enable any person skilled in the art to make or use the present invention. Various modifications to these embodiments will be apparent to those skilled in the art, and the general principles defined herein may be applied to other embodiments without departing from the scope of the invention. Therefore, the present invention is not limited to the embodiments presented herein, but is to be construed in the broadest scope consistent with the principles and novel features presented herein.

What is claimed is:

1. A device for dispersion measurement from a received signal, comprising:
a boundary checker configured to measure a shape of eye diagram of a sampled received signal; and
a dispersion quantity estimator configured to estimate a dispersion quantity based on the shape of eye diagram.

2. The device of claim 1, wherein the boundary checker is configured to determine a phase difference between an eye upper boundary peak and an eye lower boundary peak in the shape of eye diagram, and
the dispersion quantity estimator is configured to estimate the dispersion quantity based on the phase difference.

3. The device of claim 2, wherein the dispersion quantity estimator is configured to estimate a transmission distance proportional to the dispersion quantity based on the phase difference.

4. The device of claim 3, wherein the dispersion quantity estimator is configured to determine a first-order linear model between the phase difference and the transmission distance and estimate the transmission distance based on the first-order linear model.

5. The device of claim 2, wherein the dispersion quantity estimator is configured to estimate a positive dispersion quantity or a negative dispersion quantity based on a sign of a value of the phase difference.

6. The device of claim 5, further comprising a dispersion compensation filter configured to filter the received signal to reduce the phase difference based on the positive dispersion quantity or the negative dispersion quantity.

7. A method of dispersion measurement from a received signal, comprising:
measuring a shape of eye diagram of a sampled received signal;
determining a phase difference between an eye upper boundary peak and an eye lower boundary peak of the shape of eye diagram; and
estimating a dispersion quantity based on the phase difference.

8. The method of claim 7, wherein the estimating of the dispersion quantity includes determining a first-order linear model between the phase difference and a transmission distance proportional to the dispersion quantity, and estimating the transmission distance based on the first-order linear model.

9. The method of claim 7, wherein the estimating of the dispersion quantity includes estimating a positive dispersion quantity or a negative dispersion quantity based on a sign of a value of the phase difference.

10. The method of claim 9, further comprising filtering the received signal to reduce the phase difference based on the positive dispersion quantity or the negative dispersion quantity.
